(19) United States
(12) Patent Application Publication
(10) Pub. No.: US 2026/0141471 A1
(43) Pub. Date: May 21, 2026

(54) INTELLIGENT SYSTEM FOR MANAGING PRE-HEALTH EXPERIENTIAL LEARNING, PROFESSIONAL NETWORKING, AND CREDENTIAL VALIDATION

(71) Applicants: Emily Chandler, Davie, FL (US); Nikolay Boytchev, Davie, FL (US); Galina Dineva, Davie, FL (US)

(72) Inventors: Emily Chandler, Davie, FL (US); Nikolay Boytchev, Davie, FL (US); Galina Dineva, Davie, FL (US)

(21) Appl. No.: 19/391,519

(22) Filed: Nov. 17, 2025

Related U.S. Application Data
(60) Provisional application No. 63/721,052, filed on Nov. 15, 2024.

(51) Int. Cl. G06Q 50/20

(52) U.S. Cl. CPC G06Q 50/205

(57) ABSTRACT

A computer implemented platform coordinates student participation in clinical shadowing and volunteering. An application server communicates with user devices to authenticate student and professional accounts, display filtered opportunity listings, and record attendance with timestamp and geolocation captured from a student device. The platform generates a session identifier, binds the captured fields to the identifier, and transmits a validation request to a verified professional or organization leader. Upon receiving validation, the system persists a tamper resistant log entry, updates cumulative progress against program specific hour goals, and triggers reminders generated by a requirements engine. Interfaces allow in app messaging for scheduling and confirmation. An export module formats validated histories for direct electronic submission to application portals or for download, enabling end to end discovery, recording, verification, tracking, and export.

### CROSS-REFERENCE TO RELATED APPLICATIONS

The present application claims priority to U.S. Provisional Application No. 63/721,052 filed Nov. 15, 2024, titled “INTELLIGENT SYSTEM FOR MANAGING PRE-HEALTH EXPERIENTIAL LEARNING, PROFESSIONAL NETWORKING, AND CREDENTIAL VALIDATION,” which is hereby incorporated by reference in its entirety.

### TECHNICAL FIELD

The embodiments generally relate to systems and methods for managing and verifying clinical shadowing and volunteering experiences for prehealth students via a networked software platform.

### BACKGROUND

Conventional platforms for coordinating clinical shadowing and volunteering rely on general purpose tools such as spreadsheets, document repositories, and calendar services. Students typically locate opportunities through university career sites, hospital webpages, or social media listings, then record participation using manual logs or templated forms. Professionals or coordinators often confirm participation through email, physical signatures, or periodic attestations, and organizations maintain separate records for scheduling, attendance, and contact information.

Hospitals and clinics frequently use human resources or volunteer management software designed for broad organizational workflows. These systems register volunteers, schedule shifts, and track high level participation metrics. Universities and student groups often supplement with learning management systems or advising portals that collect self-reported hours and uploadable proof documents. Messaging occurs through email or in-app notes within each separate platform, and users switch between systems to complete tasks.

These conventional products emphasize administration and compliance at the organization level rather than cross-program progress for individual students. Hour logs often accumulate in multiple formats across different sites, and verification may occur after the fact rather than contemporaneously with the activity. Identity checks for professionals and organization leads typically follow general onboarding procedures without role-specific credential validation tied to hour confirmation events. Exporting records for applications commonly requires manual compilation and formatting by the student.

Public program requirement information appears across school webpages and advising guides that change over time. Students usually compare these requirements, such as accreditation status, Location, start term, application deadlines, admission tests (GRE etc.), application processes required, required shadowing, volunteer hours, other patient care experience hours, Tuition and length of program, or class size and matriculation stats, by visiting multiple sources or consulting advisors who aggregate guidance from prior terms. Existing tools provide search and bookmarking in an ad hoc manner, and requirement tracking frequently depends on user-entered targets. As a result, users perform separate steps to discover opportunities, record participation, request confirmation, track progress toward varied program thresholds, and prepare application-ready documentation.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

This summary is provided to introduce a variety of concepts in a simplified form that is further disclosed in the detailed description of the embodiments. This summary is not intended for determining the scope of the claimed subject matter. The disclosed system coordinates student engagement in clinical shadowing and volunteering by operating a networked application that authenticates student and professional accounts, displays filtered opportunity listings, and records attendance with timestamp and location metadata. A professional account validates each recorded session, and the application maintains a cumulative tracker tied to program specific hour goals. A messaging module supports scheduling and confirmation between students and professionals within the same interface.

The disclosed system addresses fragmented recordkeeping by generating structured log entries at the time of participation and binding those entries to cryptographic identifiers or digital signatures. By associating geolocation and timestamps with session identifiers, the platform creates records that resist post validation alteration. Professional and organization profiles undergo credential checks before they can post experience opportunities or verify hours, which strengthens the reliability of confirmations compared to general onboarding workflows.

The disclosed system aggregates academic program requirements into a searchable catalog and links each student profile to selected targets. An artificial intelligence engine evaluates validated progress against those targets and issues automated reminders and recommendations. In certain embodiments the reminders originate from a character persona that delivers natural language guidance tailored to remaining hours and upcoming deadlines. This proactive guidance reduces the need for users to reconcile disparate requirement sources and manual trackers.

The disclosed system further supports volunteering organizations through a dedicated module that posts opportunities, receives sign ups, and records distinct volunteering logs with validations by organization leads. A monitoring component updates cumulative progress in real time for both shadowing and volunteering and generates alerts at configurable thresholds. These coordinated functions allow students, professionals, and organizations to perform discovery, scheduling, attendance recording, and validation without switching among multiple applications.

The disclosed system exports validated logs in formats suitable for application portals and downloadable documents. In some implementations the export occurs through an application programming interface that aligns with portal specifications, which minimizes manual compilation by students. The specification includes system, method, and non transitory computer readable medium implementations so that the described functionality can run on servers in communication with user devices and can be distributed as instructions stored on computer readable media.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2 illustrates an application program and modules in communication with the computing system, according to some embodiments;

FIG. 3 illustrates a flow diagram for an example method performed by the application program executing on the computing system while communicating with a student device and a professional device over the network, according to some embodiments; and

FIG. 4 illustrates a flow diagram for an example computer readable medium that stores instructions executed by the application program within the computing system while communicating over the network with user devices, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

A networked computing environment may host an application program that executes on one or more servers and communicates with user devices over wired or wireless networks. The environment may follow a client server or cloud architecture in which user devices present graphical interfaces while an application server manages business logic, persistent storage, and external integrations. Components may exchange data over the Internet using IP based protocols, and the system may deploy as a web application, a native mobile application, or both.

A communication module may handle authenticated sessions between user devices and the application server. The module may accept HTTPS requests from mobile or browser clients, manage OAuth or token based sessions, and multiplex real time messaging for scheduling and confirmation. The module may expose application programming interfaces so that third party university portals or graduate application systems can send or receive structured data related to user profiles and validated logs. The communication module may also maintain in app messaging sessions among students, professionals, and organization leads to coordinate opportunity details.

An authentication and identity verification module may register and manage student accounts, professional accounts, organization accounts, and university administrator accounts. During professional account onboarding, the module may collect declared degree type and workplace and perform verification before enabling that account to create in-application opportunities and validate student hours. The module may store user roles and verification status in association with profile records so that downstream services can gate sensitive actions such as hour validation and opportunity posting. Universities may provision student logins tied to university affiliation and undergraduate track so that the system can apply institution specific settings. When a student's institutional affiliation terminates, such as by graduation, withdrawal, or expiration of the university's license, the platform automatically transitions the corresponding student account to a read-only archival state. In this mode, the student maintains continuous access to previously logged data, verified experiential records, and downloadable documentation, but all features related to active opportunity participation, scheduling, or communication are disabled. The archival mode thereby preserves data ownership for the student while maintaining the integrity of institutional licensing boundaries. Student users may request a license extension from their university.

A user and profile module may record and track user demographics, track selection, institution attributes, notification preferences, and contact routes. This module may retain historical usage, selected programs, and bookmarked opportunities, and it may expose profile fields to the display layer for personalization. The module may support role scoped profile views so that professionals can maintain their opportunity listings and organizations can maintain volunteering posts.

An opportunity management module may aggregate and display available clinical shadowing sessions and volunteering opportunities. The module may filter listings by university, location, and declared track so that students view a tailored catalog of opportunities and can sign up. The module may allow professionals or organization leaders to publish opportunities from their verified accounts, including time windows, locations, capacity, and any prerequisites. The module may integrate with the communication module for confirmations and reminders associated with each listing. Each listing (shadowing or volunteering) may specify role descriptions, credential or training requirements, and required documents such as waivers or consent forms. The system may support electronic signature functionality, enabling students to review and execute all required forms digitally within the platform.

Volunteering opportunities are also obtained through the platform and are posted exclusively by credentialed and approved organizations, including hospitals, public-health departments, nonprofit entities, or university-affiliated programs, that have been validated and authorized to host student volunteers. In some embodiments, the system further comprises a Partnership Verification Network for onboarding and authenticating university affiliated organizations, hospitals, and community partners. The module validates partner identity through credential registries, contractual identifiers, tax or licensing data, and third-party verification APIs. Verified partners receive a Partner Organization Credential Badge visible on listings. The subsystem may maintain a partner trust index based on verification status, activity history, and institutional reliability, thereby enabling students and universities to assess organizational credibility before engagement.

The platform supports both university-affiliated and independent organizational access structures. A university administrator may extend institutional licenses to affiliated community or hospital-based volunteer organizations, enabling secure access under university oversight. Community organizations, nonprofit organizations, or providers without university affiliation may request direct licensing from Dr. Shadow. Approval follows verification of legal identity, leadership credentials, and alignment with educational or community service goals. Both types of entities are subject to identical verification, documentation, and renewal requirements.

A session logging module may record attendance details when a student participates in an opportunity. The module may capture a timestamp and geolocation from the student device during attendance and may bind those values to a session identifier. The module may generate a cryptographic digest over selected fields and store the digest along with the raw fields to help detect post validation alterations. The module may maintain distinct data schemas for shadowing sessions and volunteering sessions so that each type can be validated by the appropriate role. In some embodiments, an “other patient care experience type” allows students to manually enter external experiences, such as paid employment, internships, or clinical support work, that were not obtained through the Dr. Shadow platform. These entries are self-reported and stored within the same unified log for completeness but are not associated with platform-facilitated scheduling or verification processes.

A validation module may route recorded sessions to a designated professional account or an organization leader for confirmation. The module may present the captured session fields to the validator and accept an explicit validation input. If the professional account lacks completed credential verification, the module may block validation actions until the verification module reports completion. Upon validation, the module may record validator identity, timestamp of confirmation, and a signature or acknowledgement bound to the original session digest. The module may expose an audit trail to authorized university users for program review.

A progress tracking and requirement engine may maintain goal models for multiple undergraduate tracks and programs. The engine may store recommended hour totals for shadowing and volunteering and may compute per student progress in real time as new validated entries arrive. The engine may generate proactive reminders that reflect remaining hours and target dates and may deliver the reminders through an in app character persona configured to send natural language prompts. The engine may also update progress dashboards and notify advising staff with read only views.

An export interface module may format validated logs for use in graduate school applications. The module may assemble entries with timestamps, locations, validators, and cumulative totals and may output a document for download, including a system watermark or cryptographic signature, or a data package for direct electronic submission to a university application system. The module may support both a file based export and an application programming interface workflow and may generate exports on demand or on a schedule initiated by the user.

A database engine may manage persistent storage for profiles, opportunities, session logs, validation events, progress metrics, and exported artifacts. The engine may provide transactional guarantees for entries to session logs and validation records and may maintain indices for fast retrieval by user, institution, date range, or requirement category. The engine may support internal databases and may couple to external storage systems to accommodate growth or archival needs. A search component may facilitate querying across logs to support program audits.

A provider subsystem further comprises an incident reporting interface enabling providers to submit structured reports to institutional administrators. Report categories may include cancellation, student nonattendance, unprofessional behavior, safety issues, or other administrative concerns. Submitted reports are routed through the communication engine to the appropriate university administrator for follow-up. Providers may also issue cancellation notices for scheduled experiences; such notices automatically trigger notifications to all affected students and administrators.

The system may present interfaces that allow a student to log in, select or bookmark opportunities, and view a schedule. When the student attends a session, the application may display a prompt to capture presence data and to request validation from a selected professional. The student may track validated totals for shadowing and volunteering separately and may view a combined summary across a selected time window. Professionals and organization leads may access dashboards showing pending validation requests and upcoming sessions that require attention.

In certain embodiments, a explore programs dashboard may utilize information obtained from publicly accessible or third-party educational sources, including institutional websites, accreditation databases, and other open academic repositories. Such information may include, but is not limited to, current program requirements and statistics such as program names, institutional locations, accreditation status, application deadlines, tuition rates, admission requirements, and related statistical or descriptive data. Student users can browse and save programs (“favorite” schools). The present disclosure does not claim ownership, authorship, or exclusivity over the public or third-party data itself. Rather, the invention pertains to the novel system, method, and interface for aggregating, cross-referencing, and displaying such information in conjunction with verified experiential learning data, student-specific goal-tracking information, and readiness analytics generated within the platform.

In some implementations a university may provision student accounts within its own tenant of the platform, and the platform may present localized branding while enforcing institution scoped access controls. Each university instance may host its catalog of available opportunities and may enable optional export directly into its graduate application process. The platform may also support a shared catalog aggregated across partnered institutions so that students can choose based on eligibility.

Data flows may follow an ordered sequence. The user and profile module may create or update a profile when a student enrolls. The opportunity management module may then filter listings by university and track and deliver them to the display layer. When the student commits to an opportunity and attends, the session logging module may capture presence data and persist a pending session. The validation module may notify the assigned professional or organization lead, who may confirm the record, which in turn updates progress metrics in the requirement engine and enables export packaging. The communication module may transmit messages and reminders throughout these transitions.

The progress tracking and requirement engine may maintain a requirements table keyed by program and track. Each entry may include recommended thresholds for total hours and suggested yearly milestones. The engine may evaluate each validated session against the selected program model and may compute remaining hours per category. The engine may schedule reminders that reference upcoming dates and may use the in app persona to deliver the messages in natural language. The engine may adjust reminder cadence based on whether the student meets interim targets.

The export interface module may assemble a normalized representation of a student's validated history. The representation may include fields such as student identifier, institution, track, experience type, session date and time, geolocation, specialty of experience, provider type, validating account identity, and cumulative totals at the time of export. The module may format this representation as a downloadable document and may also map fields to a target electronic submission interface offered by a university. The module may log each export event with a checksum so that a program reviewer may verify that the data matches the stored validated records. The program may use artificial intelligence to summarize student experiences. These summaries can provide a comprehensive overview of things students have learned and experienced in preparation for their graduate applications or future career opportunities.

The platform may support a distinct volunteering log in addition to a shadowing log. Organization leaders may maintain their own accounts to publish volunteering opportunities, receive sign ups, and validate completed hours. The system may distinguish validator roles so that volunteering validations enter the volunteering log and professional validations enter the shadowing log while both contribute to overall progress computations.

The display module may render graphical user interfaces that allow users to navigate listings, manage schedules, submit validations, and review progress. The module may display notifications and alerts that the communication module delivers, and it may refresh views as new data arrives. Interfaces may render on mobile or desktop clients and may support internationalization and institution specific branding.

The computing environment and software components described above may execute on general purpose or special purpose computers, and program modules may be distributed across remote processing devices linked through a communications network. Computer readable program instructions may implement the described logical functions, and storage may include volatile and nonvolatile media such as RAM, flash memory, magnetic disks, optical disks, RAID systems, or cloud storage. The system may run as a SaaS deployment or within an institutional private cloud, and modules may scale independently.

In operation, students may sign up for shadowing and volunteering opportunities through interfaces rendered on their devices, attend sessions, and create log entries in real time. Students may log experiences obtained outside of the Dr. Shadow platform and request verification of these experiences by professionals and organizations. Professionals and organization leaders may validate those entries from their own devices after credential verification when applicable. Universities may view progress that students choose to share and may receive exports directly or through downloadable documents. The described modules and engines provide the processing, storage, and interfaces so that a practitioner can implement the workflows across students, professionals, organizations, and universities.

Various implementations of the invention involve the technical field of systems for facilitating pre-medical, pre-health and pre-dental student engagement including operating an application server to host an application program accessible by a student device and a professional device; authenticating a student account and a professional account; displaying on the student device a listing of clinical shadowing and volunteering opportunities filtered by university and track; receiving a student selection of an opportunity; recording during attendance of the opportunity a log entry including timestamp and location metadata; transmitting to the professional device a validation request; receiving from the professional device a validation input that verifies the recorded log entry; updating a cumulative progress tracker against program-specific hour goals; and generating via an artificial-intelligence engine reminders and recommendations to complete unmet goals and are therefore necessarily rooted in computer technology. For example, the aforementioned steps are inherently computer-based and cannot be performed in the human mind. The present invention amounts to more than merely implementing the generic computer as a tool to gather, analyze, and output data because the steps of the present method, system, or product improve the systems for facilitating pre-medical, pre-health and pre-dental student engagement by providing a unified, networked platform that authenticates distinct user roles, captures attendance data with timestamp and geolocation from a student device, binds those fields to a session identifier using a cryptographic digest, routes the record to a verified professional or organization leader for electronic validation, updates a real time requirement model, and packages validated histories for direct electronic export. This solution replaces fragmented after the fact logging with contemporaneous, tamper resistant records tied to role verified validators and program specific progress computation. The system does not merely organize human activity because it applies concrete technical mechanisms that are not performed in the human mind, including secure credential gating, authenticated network messaging, structured data schemas, cryptographic binding of sensor derived fields, automated evaluation by a requirements engine, and API based application export executed by servers and client devices. Additionally, the steps of the present invention would be impossible to accomplish on pen and paper due to the volume of data being communicated and received over a network in real-time. In particular, the speed at which the steps of the present invention occur to effectuate the disclosed method, system, or product would involve large-scale, continuous wireless communication of such data. That is, the steps of the present method, system, or product are impossible to accomplish on pen and paper, cannot be accomplished as a method of organizing human activity, and amount to significantly more than merely gathering, analyzing, and outputting data. The novelty of the present invention also resides in the technical architecture and data-integration process that dynamically links public academic program data with authenticated institutional and student data, enabling individualized readiness analytics, AI-driven compatibility assessments, and exportable verification reports. The combination of these functionalities constitutes a proprietary technical framework not anticipated by prior art and is distinct from any existing static program directory or informational listing.

Implementations of the present invention include implementing (executing, running, or deploying) one or more artificial intelligence models on a computing device wherein the computing device executes the artificial intelligence model's algorithms and mathematical functions on computer hardware using machine learning libraries. The computing device implements the artificial intelligence model when it performs tasks like training, making predictions, applying the model to data, decision-making, classification, or generating outputs based on inputs. In particular, the speed at which an artificial intelligence model analyzes and transforms data to effectuate the disclosed method, system, or product would involve large-scale, continuous transformation of such data. As such, the present invention would be impossible to accomplish on pen and paper or in the human mind due to the volume of data being analyzed and transformed by the artificial intelligence model.

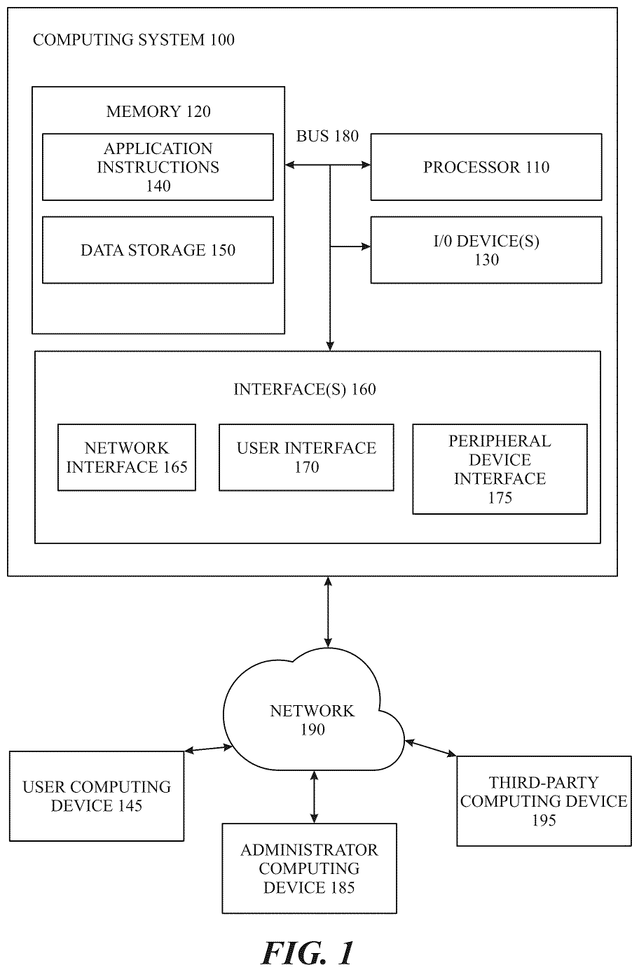

FIG. 1 illustrates an example of a computing system 100 that may provide the execution environment for implementing the processes and methods described herein. The computing system 100 may take various forms depending on deployment context, including but not limited to: a desktop or laptop computer, a tablet or smartphone, a server in a data center, a network appliance, a mainframe computer, a workstation, or a cloud-hosted virtual machine. In some embodiments, the computing system 100 may correspond to a distributed computing environment, such as a cluster of servers executing containerized workloads (e.g., Docker, Kubernetes), or an edge device integrated into Internet of Things (IoT) environments. In other embodiments, the computing system 100 may be embedded in another device, such as a vehicle infotainment unit, a medical diagnostic machine, an industrial robot controller, or a wearable computing device.

The computing system 100 includes one or more processors 110 operably coupled to a memory 120 via a system bus 180. The processor 110 may be implemented as a general-purpose central processing unit (CPU), a graphics processing unit (GPU), a tensor processing unit (TPU), a digital signal processor (DSP), or any combination thereof. In some embodiments, the processor 110 may be an application-specific integrated circuit (ASIC) optimized for a particular workload, a field-programmable gate array (FPGA), or a quantum or neuromorphic processor in advanced implementations. The processor 110 may include single-core, multi-core, or many-core configurations and may support hardware virtualization, multithreading, or parallel execution environments to optimize system performance.

The memory 120 may include volatile memory, nonvolatile memory, or a combination thereof. Volatile memory may include system RAM, cache memory, or high-bandwidth memory (HBM). Nonvolatile memory may include flash storage, solid-state drives (SSD), magnetic hard disk drives (HDD), optical storage devices, or persistent memory technologies such as Intel Optane. The memory 120 stores application instructions 140 for carrying out the functionalities described herein and data storage 150 for maintaining information related to system operations. The application instructions 140 may include code written in languages such as C, C++, Java, Python, Go, Rust, or JavaScript, as well as machine learning models trained using frameworks such as TensorFlow or PyTorch. The data storage 150 may contain structured information such as relational database records, unstructured data such as text or images, or real-time telemetry streams. In cloud-based embodiments, the memory 120 may represent scalable storage resources provisioned on-demand through Infrastructure-as-a-Service (IaaS) providers.

The computing system 100 may also include one or more input/output (I/O) devices 130. These devices may encompass visual output devices such as monitors, head-mounted displays, augmented reality (AR) glasses, or projectors; input devices such as keyboards, mice, touchscreens, styluses, or game controllers; and sensor devices such as microphones, cameras, depth sensors, biometric scanners, or environmental sensors. In industrial or medical environments, the I/O devices 130 may include robotic actuators, infusion pumps, or diagnostic imaging scanners. In vehicular environments, the I/O devices 130 may include in-cabin displays, steering sensors, and connected infotainment systems.

The computing system 100 further comprises one or more interfaces 160 that enable communication with other systems, users, or peripheral components. The network interface 165 allows the computing system 100 to exchange data with external systems across a network 190 using wired or wireless protocols. Example communication standards include Ethernet, Wi-Fi, Bluetooth, 5G, Long-Term Evolution (LTE), satellite communication, or emerging protocols such as Wi-Fi 7 or ultra-wideband (UWB). In some embodiments, the network interface 165 supports secure protocols such as HTTPS, TLS, or VPN tunneling to ensure authenticated and encrypted data transfer. The user interface 170 may include APIs, graphical user interfaces (GUIs), command-line interfaces (CLIs), or natural language interfaces enabled through speech recognition or chatbot systems. The peripheral device interface 175 enables connectivity with external hardware such as printers, external storage arrays, or specialized scientific equipment.

The network 190 represents any communication infrastructure capable of facilitating data exchange between computing entities. In some embodiments, the network 190 corresponds to a local area network (LAN) within a home or enterprise environment. In other embodiments, the network 190 may be a wide area network (WAN), a metropolitan area network (MAN), a peer-to-peer (P2P) communication mesh, or the global Internet. The network 190 may employ cloud orchestration layers, software-defined networking (SDN), or edge computing gateways. In high-security applications, the network 190 may implement firewalls, intrusion detection systems, or zero-trust architectures to protect transmitted data.

The computing system 100 is illustrated as being in communication with multiple external devices, including a user computing device 145, an administrator computing device 185, and a third-party computing device 195. The user computing device 145 may be a smartphone, tablet, laptop, or smart appliance configured to execute client-side applications or interact with system services. The administrator computing device 185 may be a workstation or remote management console configured to perform oversight functions such as monitoring, auditing, updating, or troubleshooting. The third-party computing device 195 may represent a partner system, vendor service, or external application interface that exchanges data with the computing system 100 via secure APIs. In cloud or SaaS embodiments, these devices may also include external microservices, data warehouses, or federated learning nodes.

In some embodiments, the computing system 100 may be deployed in a client-server model, where the computing system 100 acts as a backend server managing requests from client devices. In other embodiments, the computing system 100 may function within a cloud-native environment, operating as a microservice within a container orchestration platform. In edge deployments, the computing system 100 may be optimized for low-latency local processing, while synchronizing with centralized cloud infrastructure for data persistence and global coordination.

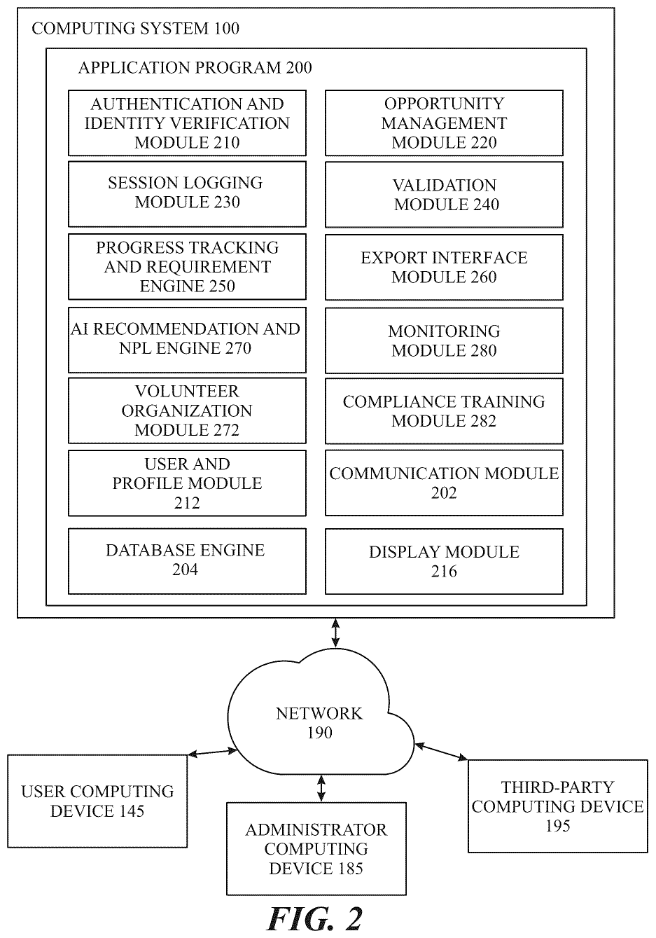

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of an authentication and identity verification 210 module, an opportunity management module 220, a session logging module 230, a validation module 240, a progress tracking and requirement engine 250, an export interface module 260, an AI recommendation and NPL engine 270, a monitoring module 280, a volunteer organization module 272, a compliance training module 282, a communication module 202, a database engine 204, a user and profile module 212, and a display module 216.

FIG. 2 illustrates a computing system 100 that executes an application program 200 hosting coordinated modules and engines that operate over a network 190 to communicate with a user computing device 145, an administrator computing device 185, and a third-party computing device 195. The user computing device may be a student device, a professional device, or an organization leader device. The administrator computing device may belong to a university or program administrator with controlled access. The third-party computing device may represent external services such as verification providers or application portals. The application program 200 may run on one or more servers and exchange data with the devices using secure network protocols so that sessions, profiles, opportunities, validations, and exports flow through defined interfaces.

A communication module 202 may manage all client-server interactions. The module may terminate TLS connections, enforce session lifecycles using tokens, and provide REST and realtime endpoints for messaging and notifications. The module may queue outbound messages to deliver scheduling confirmations and validation requests, and it may expose webhooks for third-party integrations. The module may apply rate limiting and access control lists so that requests from each role are authorized before they reach downstream services.

A database engine 204 may maintain persistent storage for the application program 200. The engine may provide transactional writes for session logs and validation records, maintain row-and document-level indices for fast retrieval by user and date range, and keep an immutable audit ledger that records updates to validated entries. The engine may encrypt data at rest, manage retention schedules for exports and artifacts, and support backups and replication across availability zones to preserve durability.

A display module 216 may render graphical interfaces on web and mobile clients. The module may assemble views that present opportunity listings, schedules, validation queues, and progress dashboards, and it may react to server events to refresh data in real time. The module may guide users through structured forms for sign-up, attendance capture, and export requests, and it may support accessibility, localization, and institution-specific branding.

An authentication and identity verification 210 module may register users, authenticate credentials, and verify professional and organization identities before those accounts can validate hours or post opportunities. The module may support multi-factor authentication, store role assignments, and perform credential checks by comparing declared degrees and workplaces with reference sources or administrator approvals. The module may publish verification status so that other modules gate actions on that status.

A user and profile module 212 may persist demographic attributes, university affiliation, undergraduate track, notification preferences, and sharing permissions. The module may record selected graduate programs and bookmarked opportunities and may expose profile data to personalize search and recommendations. The module may enforce role-based access controls so that each account views and edits only authorized fields.

An opportunity management module 220 may create, index, and deliver listings for clinical shadowing and volunteering. The module may accept posts from verified professionals or organization leaders with parameters such as location, schedule, capacity, prerequisites, and validator identity. The module may filter listings by university, track, and proximity for each student profile and may coordinate sign-ups, waitlists, and calendar updates through the communication module 202.

A session logging module 230 may capture attendance data during a student's participation. The module may obtain a timestamp and geolocation from the user computing device 145, generate a session identifier, and compute a cryptographic digest over selected fields. The module may store the raw fields and the digest in the database engine 204, handle intermittent connectivity by caching records for later sync, and separate shadowing entries from volunteering entries for downstream validation.

A validation module 240 may orchestrate confirmation workflows. The module may route pending sessions to the designated validator, present captured fields and context, and receive a validator input that confirms or rejects the record. If the validator lacks completed verification from module 210, the module may block confirmation actions. On confirmation, the module may bind the validator identity, a confirmation timestamp, and a signature or acknowledgement to the original session digest and append an entry to the audit ledger for review by authorized administrators.

A progress tracking and requirement engine 250 may maintain requirement models keyed by undergraduate track and graduate program. The engine may compute cumulative validated hours in real time as confirmations arrive from the validation module 240, evaluate remaining hours against thresholds, and update dashboards for students and advisors. The engine may support category breakdowns such as shadowing and volunteering and may apply time windows and institution-specific rules when calculating progress.

An export interface module 260 may transform validated histories into standardized outputs for application systems and downloadable files. The module may map internal fields to external schemas, produce JSON or XML payloads for API-based submission to third-party computing devices 195, and generate PDF or spreadsheet documents for user download. The module may calculate checksums for each export, store export manifests in the database engine 204, and allow administrators to reconcile submitted data with stored validated records.

An AI recommendation and NPL engine 270 may analyze profile attributes, requirement models, career readiness, and validated logs to generate opportunity recommendations and reminder messages that use natural language processing. The engine may rank opportunities based on eligibility, proximity, schedule fit, and historical engagement, and it may produce messages that reference remaining hours and upcoming milestones. The engine may adapt cadence and tone to user preferences provided by the user and profile module 212 and may hand off final delivery to the communication module 202. Aggregated recommendation data may be displayed in anonymized form to university or organizational administrators, showing participation trends, opportunity demand, and specialty interest distributions across their student population. These analytics assist institutions in identifying unmet experiential needs and adjusting offered opportunities accordingly.

A volunteer organization module 272 may support organization accounts that post volunteering opportunities and validate volunteering sessions. The module may maintain organization profiles, handle capacity management and attendance rosters, and record validations by organization leaders distinct from healthcare professionals. The module may keep a separate volunteering log while allowing the progress tracking and requirement engine 250 to aggregate totals across logs.

A monitoring module 280 may observe operational and compliance conditions across the application program 200. The module may evaluate thresholds such as inactivity on pending validations, unusual submission patterns, or approaching program deadlines, and it may emit alerts to users or administrators. The module may also expose telemetry for system health and queue backpressure so that administrators can scale resources or adjust policies.

A compliance training module 282 may manage discovery and tracking of training relevant to healthcare privacy and safety. The module may present links or embedded content for certifications, record completion artifacts, and associate completion status with the user profile so that it can be included in exports or program reviews when required.

The invention further comprises a logic engine that generates personalized readiness indicators or requirement-completion visualizations based on correlations between public program admission criteria and authenticated student data. The system may display visual or textual indicators, such as “Meets Program Requirement” or “Additional Hours Needed,” and may automatically generate application-ready reports linking verified experiential data to specific program prerequisites.

Together these components within the application program 200 interact to authenticate roles, surface tailored opportunities, capture and validate attendance with tamper resistance, compute requirement progress, generate recommendations and reminders, and export verified histories. The communication pathways through the communication module 202 and the persistence provided by the database engine 204 allow the user computing device 145, the administrator computing device 185, and the third-party computing device 195 to participate in these workflows under the control of the computing system 100 shown in FIG. 2.

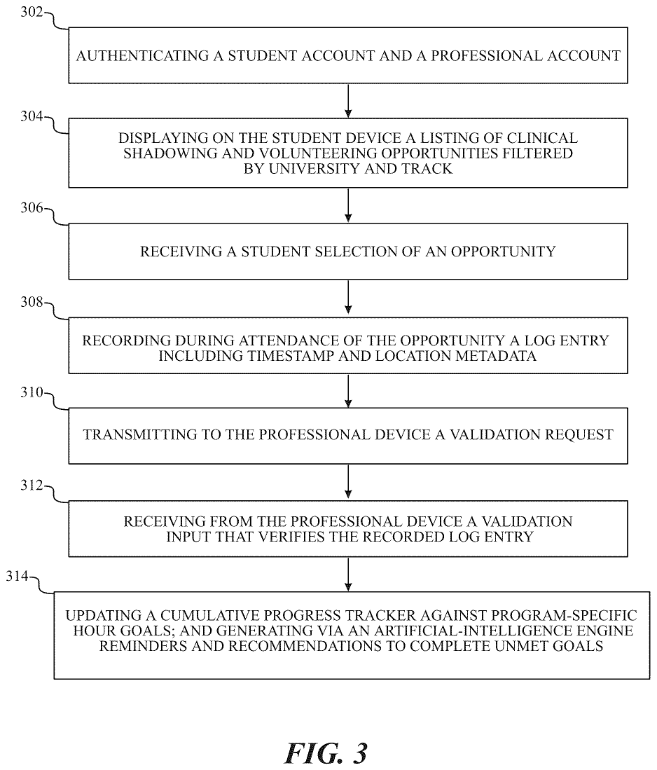

FIG. 3 depicts a flow diagram for an example method performed by the application program 200 executing on the computing system 100 while communicating with a student device and a professional device over the network 190. The method illustrates cooperation among the authentication and identity verification module 210, the opportunity management module 220, the session logging module 230, the validation module 240, the progress tracking and requirement engine 250, and the AI recommendation and NPL engine 270, together with the communication module 202, the display module 216, and the database engine 204.

At 302, the method authenticates a student account and a professional account. The authentication and identity verification module 210 establishes secure sessions for each user and applies role assignments to generate access tokens. For the professional account, the module may check declared credentials and workplace and record a verification status that downstream components consult before enabling hour validation.

At 304, the method displays on the student device a listing of clinical shadowing and volunteering opportunities filtered by university and track. The opportunity management module 220 queries listings keyed to the student's profile and the display module 216 renders a selectable catalog that may include location, schedule, capacity, and validator identity. The communication module 202 supplies the listing data to the client and maintains the session.

At 306, the method receives a student selection of an opportunity. The communication module 202 accepts the selection event and the opportunity management module 220 records an enrollment or sign up associated with the student profile. The modules may update calendars, waitlists, or reminders tied to the selected session.

At 308, the method records during attendance of the opportunity a log entry including timestamp and location metadata. The session logging module 230 captures a device sourced timestamp and geolocation, generates a session identifier, and computes a cryptographic digest over selected fields. The database engine 204 stores the raw fields and the digest as a pending record that awaits confirmation.

At 310, the method transmits to the professional device a validation request. The validation module 240 constructs a request that references the pending session and the captured fields, and the communication module 202 delivers the request through messaging or push channels. The request targets the professional account designated for the opportunity.

At 312, the method receives from the professional device a validation input that verifies the recorded log entry. The validation module 240 checks the professional's verification status from module 210, records validator identity and a confirmation timestamp, binds the confirmation to the session digest, and writes an audit trail to the database engine 204. Rejections or corrections may follow a similar path with an updated state.

At 314, the method updates a cumulative progress tracker against program specific hour goals and generates via an artificial intelligence engine reminders and recommendations to complete unmet goals. The progress tracking and requirement engine 250 computes validated totals for shadowing and volunteering relative to the student's selected programs and updates dashboards. In further embodiments, the progress tracking and requirement engine 250 provides users with the ability to edit, update, or redefine personal academic and professional goals after their initial creation. When a goal is modified, such as changes to desired shadowing hours, specialty focus, or target completion dates, the system's adaptive algorithm automatically reprojects the user's trajectory, recalculating recommended activities, timelines, and associated opportunities. This functionality ensures that goal management remains interactive and responsive to user growth, scheduling changes, or new institutional requirements, while maintaining synchronization with the platform's recommendation and scheduling engines.

The AI recommendation and NPL engine 270 evaluates remaining hours and target dates and produces natural language reminders that the communication module 202 delivers to the student device. Steps in FIG. 3 may execute in sequence as shown or with certain actions performed in parallel or repeated for multiple opportunities.

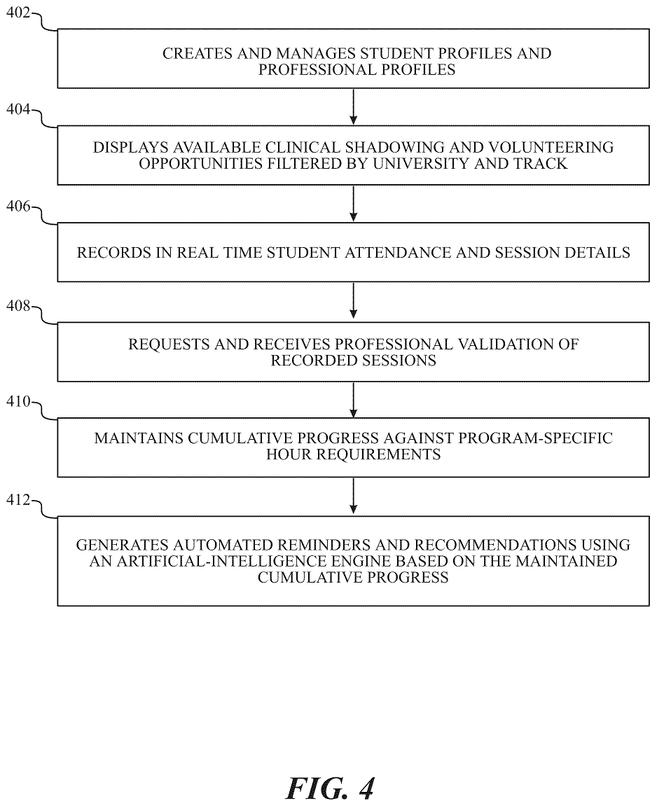

FIG. 4 shows a flow diagram for an example computer readable medium that stores instructions executed by the application program 200 within the computing system 100 while communicating over the network 190 with user devices. At 402, the stored instructions cause processors to create and manage student profiles and professional profiles using the authentication and identity verification module 210 together with the user and profile module 212. The modules register accounts, assign roles, persist affiliation and track data, and record verification status for professionals. At 404, the instructions drive the opportunity management module 220 and the display module 216 to present available clinical shadowing and volunteering opportunities filtered by university and track so that a student device renders a catalog tailored to the active profile. At 406, the session logging module 230 records in real time student attendance and session details, including a timestamp and location metadata captured from the student device and bound to a session identifier. At 408, the validation module 240 requests and receives professional validation of the recorded sessions by transmitting a validation request to the designated professional account and binding the returned validation input to the stored session record. At 410, the progress tracking and requirement engine 250 maintains cumulative progress against program specific hour requirements by computing validated totals for shadowing and volunteering and updating stored progress metrics. At 412, the AI recommendation and NPL engine 270 generates automated reminders and recommendations based on the maintained cumulative progress and delivers the messages through the communication module 202 to the student device. Steps may repeat for additional opportunities or execute in parallel where supported by the modules of the application program 200.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface. In exemplary embodiments, the system may be configured to automatically synchronize or refresh data obtained from external public sources through application programming interfaces (APIs), scheduled data imports, or web-scraping mechanisms compliant with publicly available data access policies. The synchronized data may be processed, normalized, and stored in structured format to enable comparison with student credential data, including verified shadowing hours, volunteering hours, and patient-care experiences.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A system for facilitating student engagement in clinical shadowing and volunteering opportunities related to academic program admissions, the system comprising:
at least one user computing device in operable communication with a user network;
an application server in operable communication with the user network and configured to host an application program;
a database storing user profiles and engagement records; and
the application program executable to:
authenticate a student account;
authenticate a professional account associated with a healthcare provider;
display via a display module a listing of available opportunities filtered by a university affiliation and an undergraduate track;
receive a student selection of an opportunity;
create in real time a log entry comprising a timestamp and location metadata for an attended session;
enable a professional account to validate the log entry;
operate an artificial-intelligence recommendation and natural language processing engine to generate reminders and recommendations that track required shadowing and volunteering hours for the student's program; and
provide a communication module that enables messaging between the student and the professional for scheduling and confirmation.

2. The system of claim 1, wherein the application program further comprises a credential verification routine that confirms a professional account by validating a declared degree and workplace prior to permitting validation of student hours.

3. The system of claim 1, wherein the log entry includes a secure digital signature generated by the professional account and the student account and bound to the timestamp and location metadata to prevent post-validation alteration.

4. The system of claim 1, wherein the artificial-intelligence recommendation and natural language processing engine maintains for each undergraduate track a goal model specifying program-recommended hour totals and generates automated reminders from an in-app character persona to prompt completion of unmet goals by defined dates.

5. The system of claim 1, wherein the display module further presents a catalog of graduate programs with searchable current requirements and reported class statistics for pre-health tracks, and the application program allows students to bookmark programs and export their selections.

6. The system of claim 1, further comprising a partnership-verification network configured to authenticate affiliated organizations and assign verified-partner identifiers.

7. The system of claim 1, wherein the application program includes a volunteer organization module that allows a verified organization account to post volunteering opportunities, receive student sign-ups, and validate completed volunteering hours in a separate volunteering log.

8. The system of claim 1, wherein the application program further includes a monitoring module that tracks cumulative validated shadowing hours and volunteering hours in real time and generates alerts upon reaching thresholds required by a selected university program.

9. The system of claim 1, wherein the application program provides a compliance training module that guides students through healthcare privacy certification opportunities and records progress and completion for inclusion with the engagement records.

10. A computer-implemented method for facilitating student engagement in credential-relevant experiences, the method comprising:
operating an application server to host an application program accessible by a student device and a professional device;
authenticating a student account and a professional account;
displaying on the student device a listing of clinical shadowing and volunteering opportunities filtered by university and track;
receiving a student selection of an opportunity;
recording during attendance of the opportunity a log entry including timestamp and location metadata;
transmitting to the professional device a validation request;
receiving from the professional device a validation input that verifies the recorded log entry;
updating a cumulative progress tracker against program-specific hour goals; and
generating via an artificial-intelligence engine reminders and recommendations to complete unmet goals.

11. The method of claim 10, further comprising verifying the professional account by checking a declared degree and workplace against a stored registry before enabling validation actions.

12. The method of claim 10, further comprising formatting validated log entries for direct electronic submission to a graduate program application system through an application programming interface and alternatively generating a downloadable file containing the validated log entries.

13. The method of claim 10, wherein recording the log entry comprises capturing a geolocation from the student device, generating a cryptographic digest of the timestamp, geolocation, and session identifier, and storing the digest in the database.

14. The method of claim 10, further comprising presenting a searchable catalog of graduate programs with program-specific hour requirements and enabling bookmarking of selected programs by the student account.

15. The method of claim 10, further comprising sending automated messages from an in-app character persona that communicates natural-language reminders tailored to the student's remaining hour targets and upcoming deadlines.

16. A non-transitory computer-readable medium storing instructions which, when executed by one or more processors of an application server in communication with user devices over a network, cause the processors to execute an application program that:
creates and manages student profiles and professional profiles;
displays available clinical shadowing and volunteering opportunities filtered by university and track;
records in real time student attendance and session details;
requests and receives professional validation of recorded sessions;
maintains cumulative progress against program-specific hour requirements; and
generates automated reminders and recommendations using an artificial-intelligence engine based on the maintained cumulative progress.

17. The non-transitory computer-readable medium of claim 16, wherein the instructions further cause the processors to validate a professional profile prior to enabling validation actions by checking declared credentials and workplace.

18. The non-transitory computer-readable medium of claim 16, wherein the instructions further cause the processors to generate a secure digital signature associated with a student session that binds a timestamp, a geolocation, and a professional identifier.

19. The non-transitory computer-readable medium of claim 16, wherein the instructions further cause the processors to manage a volunteer organization module that posts volunteering opportunities, records volunteering sessions, and enables validation by an organization leader distinct from a healthcare professional.

20. The non-transitory computer-readable medium of claim 16, wherein the instructions further cause the processors to compile validated shadowing and volunteering logs into a document formatted for export to a graduate program application portal and for download to a student device.
